(19) United States
(12) Patent Application Publication
(10) Pub. No.: US 2011/0079967 A1
(43) Pub. Date: Apr. 7, 2011

(54) WINCH WINDER ADAPTER FOR A ROTARY POWER TOOL AND METHOD

(75) Inventor: REESE T. PRESLEY, HAMILTON, IN (US)

(73) Assignee: PROSTAR SOLUTIONS, LLC, HICKSVILLE, OH (US)

(21) Appl. No.: 12/894,657

(22) Filed: Sep. 30, 2010

Related U.S. Application Data
(60) Provisional application No. 61/249,289, filed on Oct. 7, 2009.
(60) Provisional application No. 61/315,614, filed on Mar. 19, 2010.

(51) Int. Cl. B25F 3/00; B66D 1/00

(52) U.S. Cl. 279/145

(57) ABSTRACT

A winch winder adapter for a rotary power tool, such as a drill or power screwdriver, to quickly and easily wind-up the strap on the winch bracket. For example, the strap may be wound up by inserting the adapter into the collar of the winch drum and actuating the rotary power tool. The high speed output rotation of the tool rotates the adapter which, when coupled to the collar, quickly rotates the drum and winds-up the strap. This can be helpful especially when there may be numerous cargo strap winches along the length of a cargo vehicle.

### PRIORITY CLAIM

This application claims the benefit of Application Ser. Nos. 61/249,289 and 61/315,614 filed Oct. 7, 2009 and Mar. 19, 2010, respectively. Each of these provisional applications is hereby incorporated by reference in its entirety.

### TECHNICAL FIELD

The present invention generally relates to winch winding assist assemblies. In particular, this invention relates to adapters for rotary power tools, such as power screwdrivers and drills, that can be used to wind, strap, or web winches, which are often used with cargo vehicles, such as flatbed trailers, railroad cars, shipping, and the like.

### BACKGROUND

Tie downs on cargo transports are very important. For example, flatbed trailers hauling large cargo often need straps to hold the cargo down. Because the straps are large, heavy duty, and used often, many flatbed trailers have strapping systems already built in. Typically, several rolls of straps are spaced along the length of the trailer. Each strap is wound around its own winch assembly. The winch not only stores the strap while not in use, but it also rolls the slack out of the strap while holding down cargo.

The winch assembly is illustratively composed of a U-shaped bracket with a drum disposed therebetween. A ratchet and pawl-like or other similar system allows the strap to be rolled up, but not rolled back out unless the pawl is disengaged. The bracket also includes a collar extending from the end of the drum. Wrapping the strap back up, however, is a relatively slow and cumbersome process that is done by hand. Therefore, there is a need for a device that allows the strap to be wrapped back up in a manner timely and efficient manner.

### SUMMARY

One aspect of the invention provides a winch winder adapter that employs an electric hand drill to quickly and easily wind-up the strap on the winch bracket. In this embodiment, the strap may be wound up by the drill pushing an adapter into the collar of the winch drum and pressing the drill's “on” button. The high speed rotation of the drill rotates the adapter which, when coupled to the collar, quickly rotates the drum and winds-up the strap. This can be helpful especially when there may be numerous cargo strap winches along the length of the trailer bed.

Embodiments are contemplated in which a winch winder includes a cylinder or tube with a shank extending therefrom. The shank is configured to attach to the chuck of a hand drill or the like in any conventional manner. Inside the cylinder is a shaft extending illustratively from the shank to the other end of the cylinder. An illustrative detent extends transversely through a hole in the wall of the cylinder. The detent includes a transverse bore itself configured to receive a cam surface portion of the shaft. This cam surface is illustratively arcuate or angled as it extends through the bore of the detent. A spring is positioned between an abutment on the shank and a collar to provide a bias force against the shank. The effect of this bias is to pull the cam surface from the detent so the detent recedes into the cylinder. Conversely, the drill can push the shank and abutment inside the cylinder against the bias force of the spring, thereby pushing the cam surface of the shaft through the bore in the detent. The curved or angled cam surface of the shaft pushes on a portion of the bore surface of the detent, effectively lifting the detent out of the cylinder. Because the abutment pushes the shaft relative to the cylinder, an illustrative embodiment of that shaft extends from the opposite opening of the cylinder when the detent extends transversely from the cylinder. A cap is illustratively attached to the distal end of the shaft. Bias force from the spring restores the positioning of the parts in the cylinder, thereby receding the detent. The cap prevents the spring from pushing all the components apart. In other words, the cap limits the movement of the shaft in the direction of the spring bias.

By extending the detent out of the cylinder, it may couple with holes already disposed in the collar. This coupling causes the winch drum to rotate as the drill chuck rotates. In alternative embodiments, the collar on the winch may receive a cylinder that friction or interference fits therewith to wind the strap.

According to another embodiment, the winch winder adapter is configured to fit into winch winder assemblies having collars of various diameters. Having a single adapter so configured enables the operator to wind-up straps without having to worry about whether it is sized for a particular winder collar. This makes the winding process much easier and faster. In an illustrative embodiment, the adapter includes a conically-shaped end that can be inserted into the collar. The conical shape of the adapter provides an inherent range of compatible collar diameters it can be inserted into. The adapter is inserted into the collar as much as needed until it engages the collar's edge. The adapter's conical body can be illustratively made of a resilient rubber or plastic material. The body can deform enough to add a frictional abutment or connection between itself and the collar. When the adapter is attached to a drill, for example, rotating the adapter will likewise rotate the collar. The friction between the two structures is enough to cause both to rotate until the strap is wound up.

According to another aspect, the invention provides a method for winding a winch winder using a rotary power tool. A shank of a winch winder adapter is connected to a chuck of a rotary power tool. The adapter includes a body extending from the shank that rotates concomitant with the shank. A leading end of the body is inserted into an opening in a rotatable collar of a winch winder. This allows at least a portion of the body to be coupled with the collar such that rotation of the body causes concomitant rotation of the collar. The winch winder may then be wound by actuating the rotary power tool to rotate the collar. In one embodiment, the coupling step includes the step of deforming at least a portion of the body to form a frictional engagement between the adapter and the collar. Embodiments are also contemplated in which the coupling step includes the step of extending a detent into a transverse hole in the collar to form an interference engagement between the adapter and the collar.

Additional features and advantages of the winch winder adapter will become apparent to those skilled in the art upon consideration of the following detailed descriptions exemplifying the best mode of carrying out the winch winder adapter as presently perceived.

### BRIEF DESCRIPTION OF THE DRAWINGS

The present disclosure will be described hereafter with reference to the attached drawings which are given as non-limiting examples only, in which:

FIG. 1 is a prospective view of an example winch winding adapter according to an embodiment of the invention that is attached to the drill;

FIG. 2 is a prospective view of the example winch winding adapter of FIG. 1 that is coupled with the collar of a winch winder;

FIGS. 3 and 4 are prospective views of the example winch winder adapter of FIG. 1;

FIGS. 5 and 6 are side cross-sectional views of the winch winder adapter 12 of FIG. 1;

FIG. 7 is a perspective view of an example winch winder adapter according to another embodiment of the invention;

FIG. 8 is a perspective view of the example winch winder adapter of FIG. 7 attached to a drill;

FIG. 9 is a perspective view of the example winch winding adapter of FIG. 7 inserted into the opening of the winch winder's collar;

FIGS. 10 and 11 are perspective views of example winch winder assemblies with different sized openings;

FIG. 12 is a cross-sectional view the example winch winding adapter of FIG. 7 inserted into a winch winder's collar;

FIG. 13 is a perspective view of the example winch winding adapter of FIG. 7 showing the body 102 deformed by virtue of its engagement with a winch winding collar; and

FIGS. 14 and 15 show example winch winder adapters according to other embodiments of the invention.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

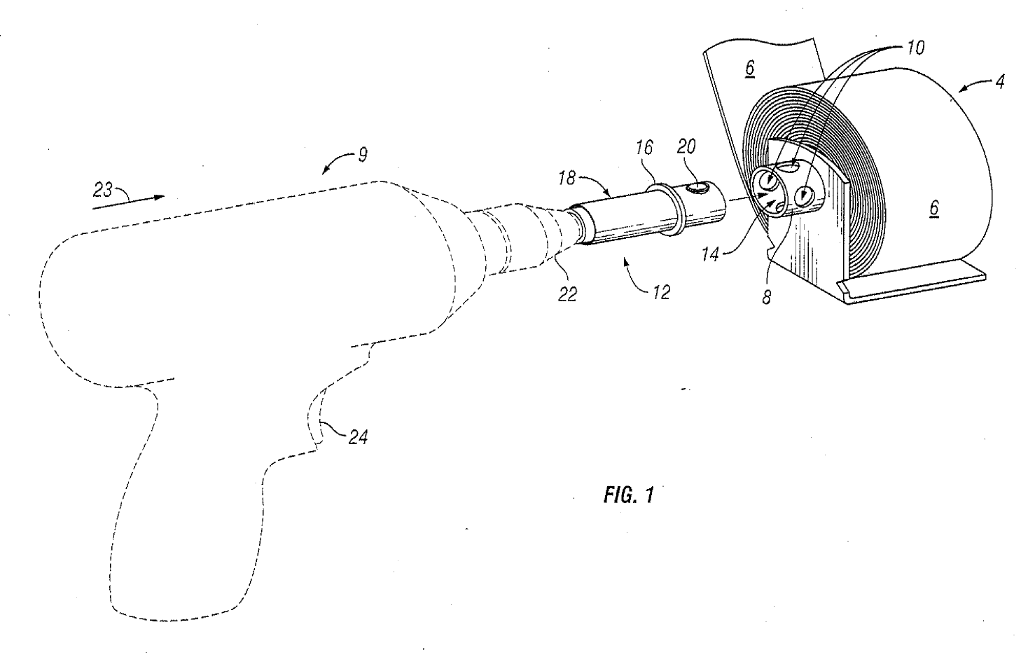

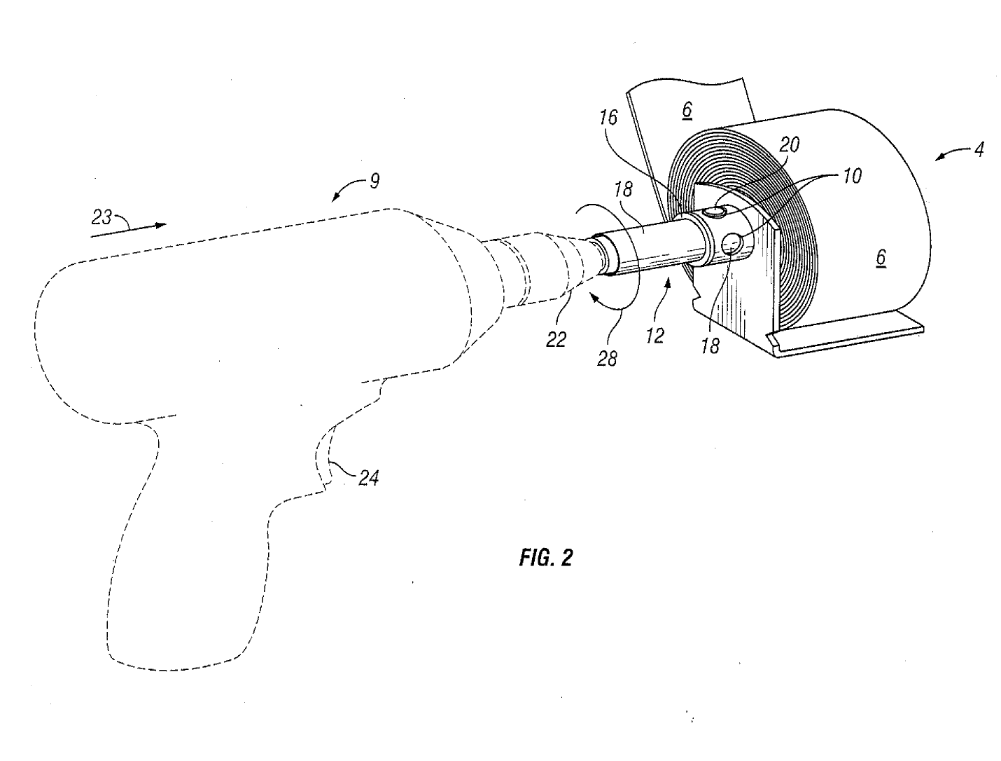

FIG. 1 is a prospective view of an example winch winder 4 along with a rotary power tool, which in this example is a drill 9. Although a drill is shown for purposes of example, one skilled in the art should appreciate that other rotary power tools could be used, including but not limited to a power screwdriver. As shown, an example winch winding adapter 12 constructed according to an embodiment of the invention is attached to the drill 9. As shown, the example winch winder 4 includes a strap 6 and a collar 8 with bores 10 disposed transversely therethrough. In the embodiment shown, the adapter 12 is configured to illustratively have its distal end extend into a longitudinally-extending opening 14 of the collar 8. A flange 16 on a tube 18, which is cylindrical in this example, extends from the winding adapter 12 to limit the amount that the tube 18 can extend into the opening 14 of the collar 8. This can be useful so that a detent 20 shown in its recessed configuration in the tube 18 can be aligned with a hole 10 disposed in the collar 8. As will be seen further herein, the detent 20 is extendable outwardly from tube 18 and is engageable with the periphery of a hole 10 in order to create an engagement between the collar 8 and the adapter 12. The combination of the tube 18 and the flange 16 can make the act of inserting the adapter 12 into the opening 14 an easy matter, requiring little more than pushing against the drill 9 in direction 23 until the adapter 12 seats within the collar 8. (See also FIG. 2.) As shown in the example embodiment of FIG. 1, the adapter 12 is attached to the chuck 22 so that when the trigger 24 of the drill 9 is activated, the adapter 12 rotates in concert with the chuck 22.

FIG. 2 is a prospective view of the example winch winding adapter 12 shown in FIG. 1 that is coupled with the collar of the winch winder 4. This view particularly shows how the adapter 12 engages the collar 8 up to the flange 16 in this embodiment. As shown, the detent 20 engages hole 10 while a portion of the tube 18 is disposed in the hole 14 of the collar 8. (See also FIG. 1.) In this embodiment, when the trigger 24 is actuated, the chuck 22 rotates in direction 28. This causes the adapter 22 to rotate in direction 28 as well. Because the detent 20 extends and engages the hole 10, as adapter 12 rotates in direction 28, so too does the collar 8. Also, because the collar 8 is attached to a drum (not shown) upon which the strap 6 is wound, rotating or winding collar 8 and the attached drum also winds up the strap 6.

As shown in this view, the flange 16 limits the extent to which the tube 18 can extend into the opening 14 of the collar 8. This means that in this embodiment, all that is necessary to make the coupling between the adapter 12 and the collar 8 is pushing the drill 9 in direction 23, which is not a difficult task.

The embodiment shown employs detent 20 to make a physical engagement with the hole 10 to cause the collar 8 to rotate with the adapter 12. It is appreciated that in other embodiments, the tube 18 may employ a friction or interference fit into opening 14 to rotate collar 8.

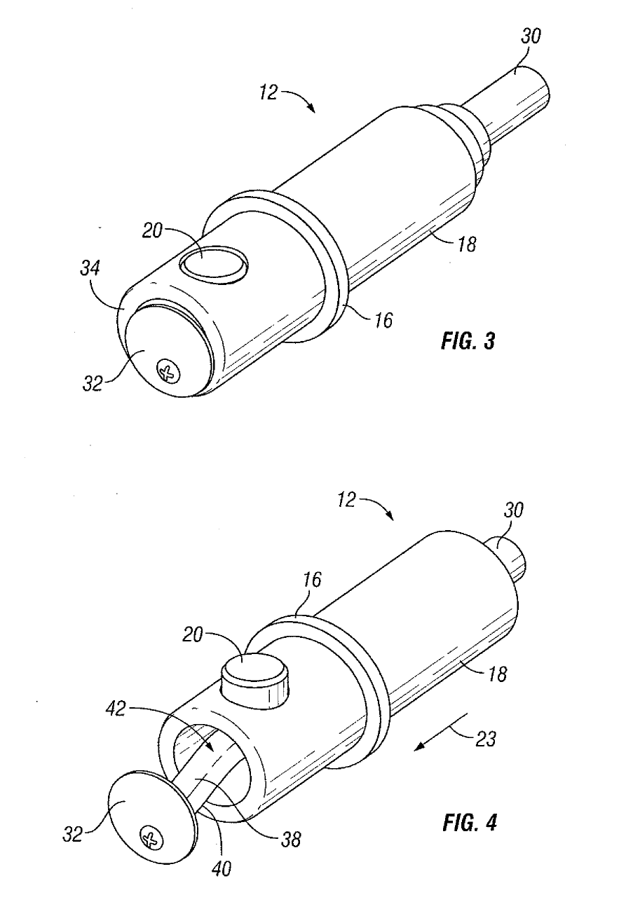

FIGS. 3 and 4 are prospective views of the example winch winder adapter 12 of FIG. 1. The view shown in FIG. 3 depicts the adapter 12 with the detent 20 located in the recessed position. This view also shows a shank 30 extending from the tube 18 and a cap 32 covering the distal end 34 of the tube 18. This view also shows the flange 16 bifurcating portions of tube 18 to limit the extent to which the distal portion 34 of the tube 18 can extend into the opening 14 of the collar 8. (See FIGS. 1 and 2.)

The view shown in FIG. 4 is similar to that of FIG. 3 except for the detent 20 extending transversely from the tube 18. As discussed further herein, an illustrative embodiment of extending detent 20 is via cam surfaces 38 and 40 on an angled or arcuate portion of a shaft 42. As shown in this example, the shaft 42 extends in direction 23, so too does shank 30. This is because when the chuck 22 of the drill 9 is attached to the shank 30 and the drill 9 inserts the adapter 12 into the collar 8 up to the flange 16, the shank 30 is moveable independent of the tube 18 and still extend forward in direction 23 even as movement of the tube 18 stops. Movement of the shank 30 moves the shaft 42 and that movement assists moving detent 20 as shown.

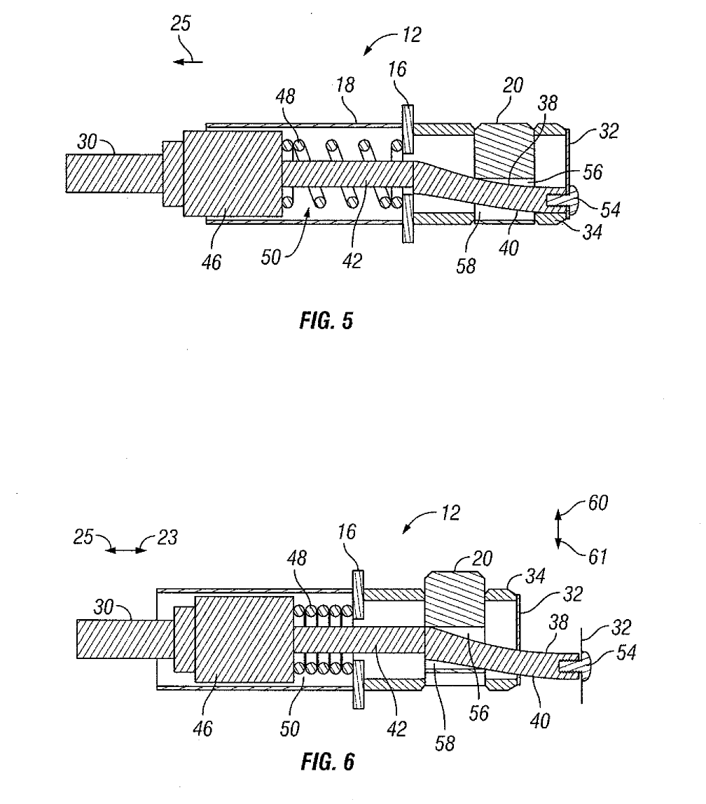

FIGS. 5 and 6 are side cross-sectional views of the winch winder adapter 12 of FIG. 1. The position of the detent 20 depicted in FIG. 6, similar to that shown in FIG. 3, is recessed in tube 18. This view also shows the positioning of the shank 30 and its connection to an abutment 46 and attachment to the shaft 42. A spring 48 is disposed in space 50 within the tube 18 between the flange 16 and the abutment 46. The bias of the spring 48 is urged towards direction 25, since the flange 16 is fixed with respect to the tube 18, whereas the abutment 46 and the shank 30 are moveable. In the example embodiment, a fastener or screw 54 attaches the cap 32 to the shaft 42. The cap 32 attached to the distal end 34 prevents the spring 48 from pushing the shank 30, abutment 46, and shaft 42 out of the tube 18. It is appreciated that other means, such as alternate fasteners, adhesives, welding and the like, can be used to attach the cap 32 and the shaft 42 together.

This view also shows an example arcuate shape of a portion of shaft 42 for purposes of illustration. This shape makes a portion of the shaft 42 offset from the center axis of the shank 30 and the abutment 46. The shaft 42 extends through a bore 56 disposed through the detent 20. In the example shown, to move the detent 20 to the recessed position, the cam surface 40 engages a wall surface 58 of the bore 56 drawing the detent 20 towards the tube 18.

The view shown in FIG. 6 differs from FIG. 5 in that the shaft 42 is extended from the tube 18 causing the detent 20 to extend transversely from the longitude axis of the tube 18, abutment 46, shank 30, and a portion of shaft 42, as shown. The shank 30 and the abutment 46 are moveable within the tube 18 against the bias force of the spring 48 compressing the same against the flange 16. With the shaft 42 attached to the abutment 46 and the shank 30, movement of the latter moves the shaft 42 so a portion extends from the distal end 34 of the tube 18. The effect of this is that the surface 58 of the bore 56 rides along the cam surface 38 of the shaft 42. The curve of the shaft 42 is so configured that the detent 20 is pushed upward in direction 60. In this example embodiment, this movement occurs because the arcuate shape of the cam surface 36 gradually increases as the shaft 42 is moved in direction 23. The cap 32, along with the end of the shaft 42, is spaced apart from the tube 18 as previously discussed. This view further assists in illustrating how simply pushing the drill 9 in direction 23 so that the flange 16 of the adapter 12 abuts the collar 8 of the winch winder 4, reciprocates and engages between the collar 8 and the assembly 12. By simply continuing to push in direction 23, even after tube 18 has stopped, this internal mechanism of the adapter 12 continues to move in direction 23 pushing detent 20 in direction 60.

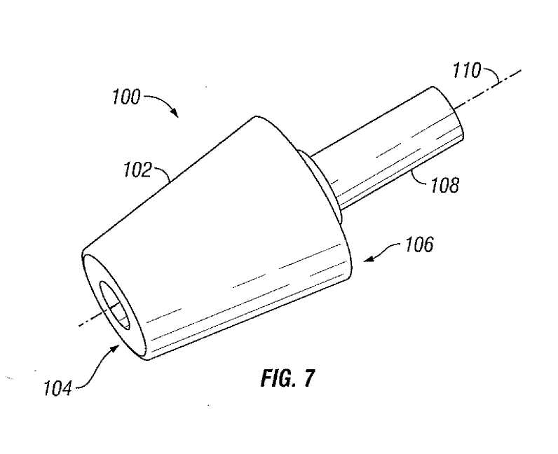

Once the automatic winding is finished, to move the adapter 12 from the collar 8, pulling the shank 30 in direction 25, i.e., the direction of bias of spring 48, pulls shaft 48 in direction 25 as well. This causes the cam surface 40 on shaft 38 to engage the lower portion of the surface 58 and bore 56, as shown in FIG. 7. The downward angling, as shown in this example, causes the detent 20 to drop in direction 61 into the tube 18. With the detent 20 recessed back into the tube 18, the continued pulling of the shank 30 in direction 25 serves to extricate the adapter 12 from the collar 8.

FIG. 7 is a perspective view of an example winch winder adapter 100 according to another embodiment of the invention. In this example, the winch winder adapter 100 has a substantially frusto-conical shaped body 102 tapered at a distal end 104 and gradually widening toward a proximal end 106 at shank 108. The body 102 is made from a suitable rubber or plastic that can grip the winch winder collar. In the example shown, the shank 108 extends from the proximal end 106 of the body 102 and along the body's axis of rotation 110. This is so the body 102 will rotate when attached to a drill (or other rotary power tool).

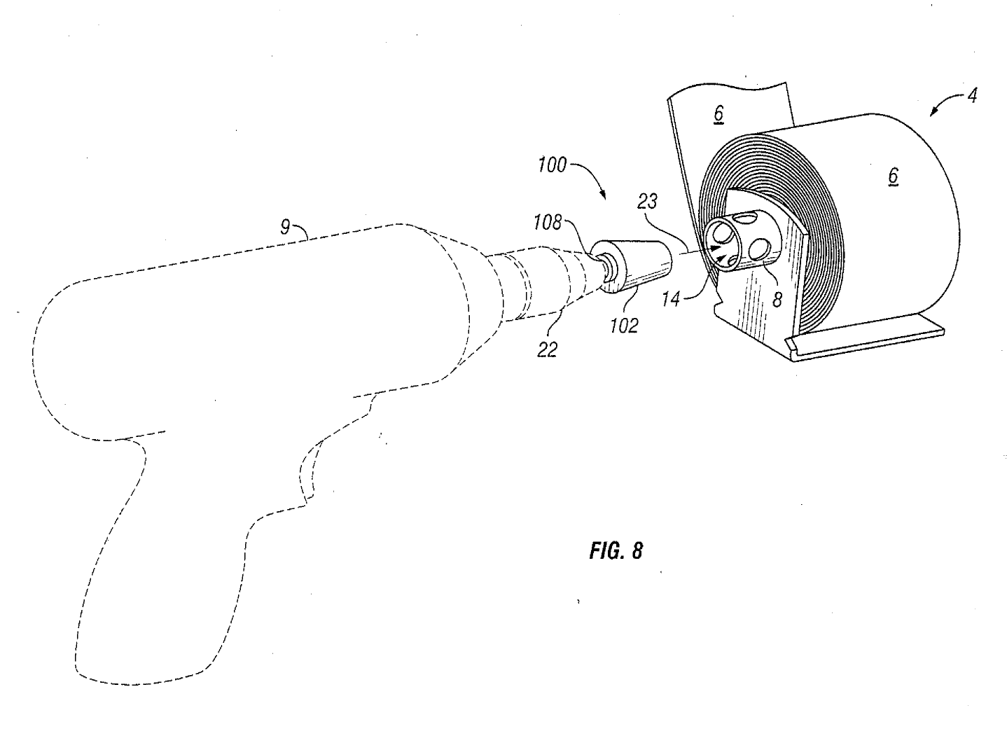

FIG. 8 is a perspective view of the example winch winder adapter 100 of FIG. 7 attached to a power drill 9 and configured to engage the winch winder 4 similar to that shown in FIG. 1. Also similar to that shown in FIG. 1, the winch winder 4 includes an opening 14 of a collar 8. As shown, the frusto-conical shape of the body 102 is configured to insert into the opening 14. The resilient and/or gripping characteristics of the rubber or plastic of the body 102 grips and rotates the collar 8 to wind the strap 6. By pushing the drill 9 in direction 23, as previously discussed with respect to the adapter 12 of FIG. 1, the adapter 100 engages the collar 8. It is appreciated that the shank 108 on the adapter 100 can insert into the chuck 22, also previously discussed with respect to the adapter 12, to hold the adapter 100 while rotating.

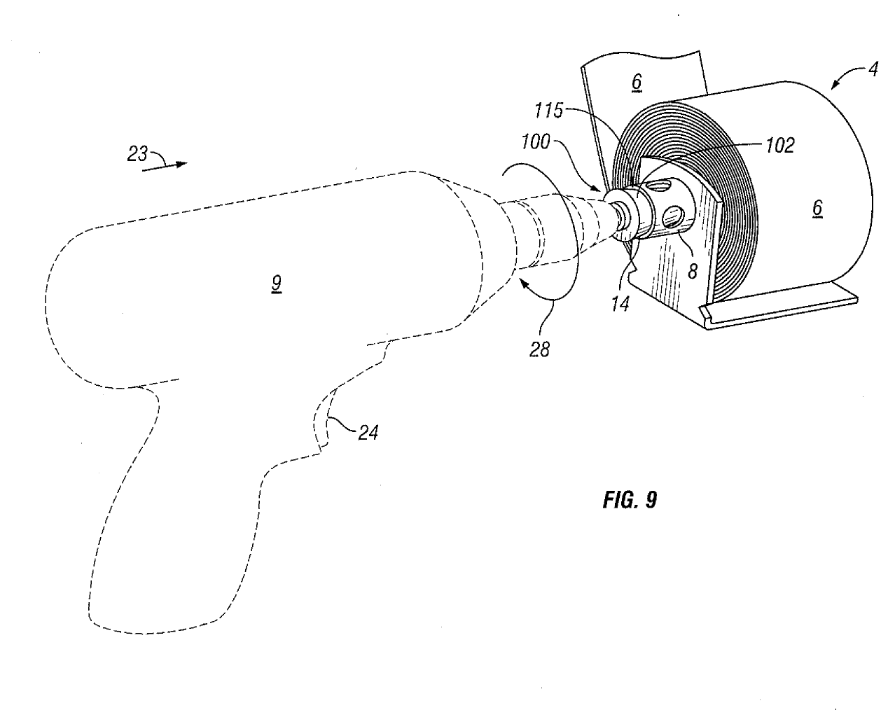

FIG. 9 is a perspective view of the drill 9 with the example winch winding adapter 100 of FIG. 7 attached thereto inserted into the opening 14 of the collar 8. This view shows the utility of the tapered head 102 on the adapter 100. The narrow distal end 104 of the adapter 100 is initially inserted into the opening 14. The adapter 100 continues to extend into opening 14 until the girth of the body 102 becomes wide enough to engage the inner edge 115 of the collar 8. The edge 115 along with the inner surface of the collar 8 can be used as a gripping surface to rotate collar 8 illustratively in direction 28 as shown. The body 102 employs a temporary frictional bond between itself and the collar 8 while rotating.

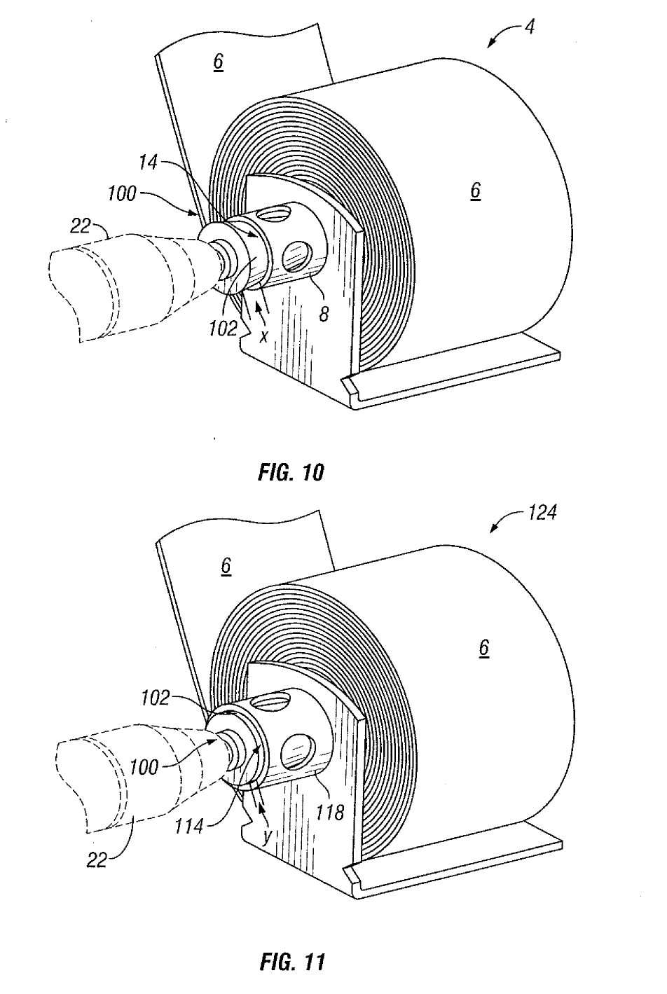

FIGS. 10 and 11 are perspective views of winch winder assemblies 4 and 124, respectively. These views demonstrate how the same winch winding adapter 100 can be used with winch winding collars with openings of different diameters. As FIG. 10 shows, the collar 8 has an opening 14 that is a relatively smaller diameter than the opening 114 of the collar 118 of winch winder 124 from FIG. 11. As shown, the adapter body 102 in FIG. 10 extends into opening 14 with a distance X remaining. By contrast, as seen in FIG. 11, the remaining distance of the same adapter 100 disposed in opening 114 of collar 118 is Y. Distance Y, as shown, is much smaller than distance X. In either case, however, both winders 4 and 124 can be wound using the same winding adapter 100.

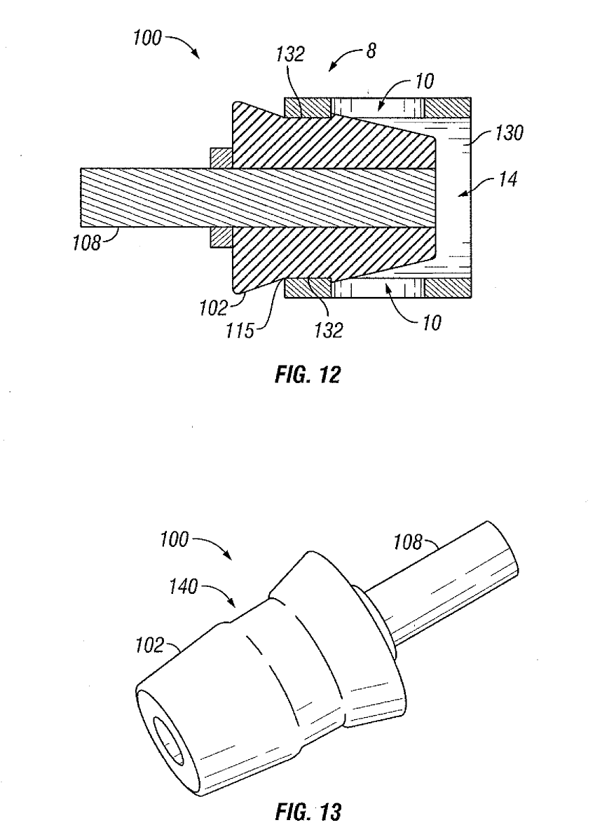

FIG. 12 is a cross-sectional view of the collar 8 and the winch winding adapter 100. This is an illustrative embodiment demonstrating a type of deformation that the body 102 of the adapter 100 can be subjected to, as well as demonstrating the potential amount of surface area body 102 may grip inside the adapter 8 in order to rotate the winch winder. As shown herein, the opening 14 includes a surface area 130. The surface of the body 102 when inserted into the opening 14 can deform providing a gripping surface 132 between the body 102 and the surface area 130. In addition, the connection at edge 115 between the body 102 and the collar 8 can further assist in rotating the winch winder. It is appreciated that the precise amount and configuration of the grip between the body of the winch winding adapter and the inner surface of the winch winder collar can vary depending on the gripping and deformation characteristics of material used. For example, using materials on the adapter 100 that can produce a high coefficient of friction with collar 8 will make it easier for adapter 100 to rotate the winch winder. The body materials, such as rubber or plastic that might have a lower coefficient of friction but can have an increase contact between themselves and the surface of the collar can, likewise, rotate the winch winder.

FIG. 13 is a perspective view of the adapter 100 showing the body 102 deformed by virtue of its engagement with a winch winding collar indicated by reference numeral 140. It is appreciated that based on the material used and particularly its resiliency, an impression of the interior contact portions of the collar can be formed in body 102. It is appreciated that depending on the resiliency of the material such impressions may be temporary, permanent, or semi-permanent.

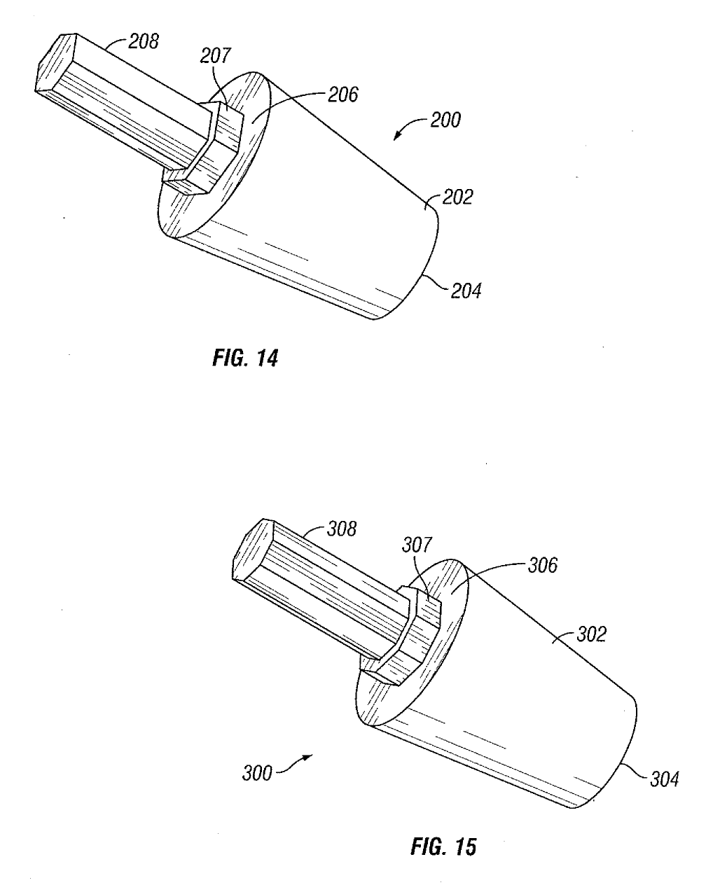

FIGS. 14 and 15 show another example embodiment of the winch winder that includes adapters 200 and 300, respectively. As shown in FIG. 14, the adapter 200 includes a frusto-conical shaped body 202 tapered at a distal end 204, similar to prior embodiments. This embodiment also gradually widens towards a proximal end 206, also similar to prior embodiments. Here, however, the adapter 200 includes a hexagonal core 207 that is at least partially inserted into the body 202. Employing a core with straight sides may help prevent the body 202 from stripping or separating itself from the core 207 when substantial torque is applied. This embodiment further shows shank 208 having an octagonal cross-section as well. This cross-section helps the drill 9 to better grip the adapter 200.

The adapter 300, as shown in FIG. 15, is similar to adapter 200 with the frusto-conical shaped body 302, tapered distal end 304, and proximal widened end 306. The adapter 300 differs from the prior embodiments, however, in that it has an octagonal core 307 and shank 308. This embodiment provides another means to help prevent the body 302 from stripping or otherwise separating from the core 307 by virtue of the additional straight surfaces. Embodiments are contemplated in which the core 307 and shank 308 could have other cross-sectional shapes, such as rectangular, triangular, or other polygons.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. An adapter for a rotary power tool to wind a winch winder having a rotatable collar with an opening, the adapter comprising:
a frusto-conical body tapered from a proximal end to a distal end, wherein at least a portion of the body is dimensioned to be received by an opening in a collar of a winch winder;
a shank extending from the body's proximal end and rigidly coupled with the body such that rotation of the shank causes concomitant rotation of the body, wherein the shank is dimensioned to be driven by a rotary power tool; and
wherein the body includes a gripping portion formed from a deformable material, wherein the gripping portion deforms when the body is inserted into the opening in the collar to frictionally engage an inner surface of the collar so that rotation of the body rotates the collar.

2. The adapter of claim 1, wherein substantially the entire body is formed from a deformable material.

3. The adapter of claim 3, wherein the body is formed from one or more of a deformable rubber or plastic.

4. The adapter of claim 1, wherein the shank extends along an axis of rotation of the body.

5. The adapter of claim 1, wherein the shank is dimensioned to be inserted into a chuck of a drill.

6. The adapter of claim 1, wherein the gripping portion is formed from a resilient material that substantially restores a deformity of the gripping portion when the body is removed from the collar.

7. The adapter of claim 1, wherein at least a portion of the shank extends into the body.

8. The adapter of claim 7, wherein the portion of the shank that extends into the body has a cross-sectional shape with at least one vertex.

9. The adapter of claim 7, wherein the portion of the shank that extends into the body has a polygonal cross-sectional shape.

10. The adapter of claim 7, wherein the portion of the shank that extends into the body has a cross-sectional shape of either an octagon or hexagon.

11. The adapter of claim 7, wherein at least a portion of the shank extends between the proximal end and the distal end of the body.

12. An adapter for a rotary power tool to wind a winch winder having a rotatable collar with an opening, the adapter comprising:
a tube having a proximal end and a distal end, wherein the tube defines an internal cavity;
a detent disposed at least partially within the internal cavity of the tube, wherein the detent is movable between an extended position that extends outwardly from the tube and a retracted position within the internal cavity, wherein the detent positioned to be alignable with a transverse hole disposed in a collar of a winch winder so that when the detent is in the extended position, the detent engages the periphery of the hole to create an engagement between the collar and the adapter;
a shank extending from the proximal end of the tube, wherein the shank is operably coupled with the tube such that rotation of the shank causes concomitant rotation of the tube, wherein the shank is dimensioned to be driven by a rotary power tool, wherein the shank is movable between a first position and a second position;
a shaft disposed at least partially within the internal cavity of the tube and extending from the shank, wherein the shaft moves toward a detent engaging position when the shank moves toward the second position and the shaft moves toward a detent disengaging position when the shank moves toward the first position, wherein the shaft moves the detent to the extended position when moving toward the detent engaging position; and
a spring urging the shank toward the first position.

13. The adapter of claim 12, wherein the tube includes an outer flange configured to limit a depth with which the tube can be received within the collar.

14. The adapter of claim 12, wherein the shaft includes at least one cam surface configured to move the detent to the extended position when the shaft moves toward the detent engaging position.

15. The adapter of claim 12, wherein the shaft includes at least one cam surface configured to move the detent to the retracted position when the shaft moves toward the detent disengaging position.

16. The adapter of claim 12, wherein the shank is linearly movable independently of the tube.

17. The adapter of claim 12, further comprising a cap covering the distal end of the tube, wherein the cap limits movement of the shank to the first position.

18. A method for winding a winch winder using a rotary power tool, the method comprising the steps of:
connecting a shank of a winch winder adapter to a chuck of a rotary power tool, wherein the winch winder adapter includes a body extending from the shank that rotates concomitant with the shank;
inserting a leading end of the body into an opening in a rotatable collar of a winch winder;
coupling at least a portion of the body with the collar such that rotation of the body causes concomitant rotation of the collar; and
winding the winch winder by actuating the rotary power tool to rotate the collar.

19. The method of claim 18, wherein the coupling step includes the step of deforming at least a portion of the body to form a frictional engagement between the adapter and the collar.

20. The method of claim 18, wherein the coupling step includes the step of extending a detent into a transverse hole in the collar to form an interference engagement between the adapter and the collar.
